(19) United States
(12) Patent Application Publication
(10) Pub. No.: US 2008/0115215 A1
(43) Pub. Date: May 15, 2008

(54) Methods, systems, and computer program products for automatically identifying and validating the source of a malware infection of a computer system

(76) Inventor: Jeffrey Scott Bardsley, Durham, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/590,113

(22) Filed: Oct. 31, 2006

(51) Int. Cl. G06F 12/14; G06F 11/00; G06F 12/16; G06F 15/18; G08B 23/00

(52) U.S. Cl. 726/24

(57) ABSTRACT

The subject matter described herein includes methods, systems, and computer program products for automatically identifying and validating the source of a malware infection of a computer system. According to one method, an indication of detection of malware on a computer system is received. At least one data transfer operation performed prior to a time associated with the indication is repeated. Results of the at least one data transfer operation are monitored for identifying a data transfer operation associated with the malware detection. In response to identifying a data transfer operation associate with the malware detection, an action is taken based on the identified data transfer operation.

### TECHNICAL FIELD

The subject matter described herein relates to identifying the source of malware infection of a computer system. More particularly, the subject matter described herein relates to methods, systems, and computer program products for automatically identifying and validating the source of a malware infection of a computer system.

### BACKGROUND

Malware, as used herein, refers to any unauthorized software that is present on a user's computer system. Examples of malware include viruses, worms, and spyware. Some malware may have relatively benign purposes, such as tracking a user's shopping habits, while other malware may have a more malevolent purpose, such as destruction or acquisition of confidential information.

Software solutions have been developed to detect and remove malware from computer systems. For example, antivirus software exists for identifying viruses and removing the viruses from a user's computer system. The antivirus software may also inform the user that a file infected with a virus has been cleaned. Solutions also exist for detecting and removing spyware.

One problem with conventional malware detection and removal software is that it does not correlate the malware infection with the source of an infection or take action to modify a user's behavior. For example, a conventional antivirus program does not take any steps to determine the source of a virus or inform the user of the source. As a result, if the malware was communicated to the computer system over a network, the user may reinfect the computer system if the user recontacts the malware source.

One conventional solution for preventing malware reinfection analyzes communication history associated with a computer system to identify a time range during which malware may have been stored on the computer system. However, this conventional solution does not identify or validate the malware source. The name of the infected file and the time range of the infection are communicated to the user. The user must then manually determine or try to determine the source of the malware.

Accordingly, in light of these difficulties associated with conventional malware identification software, there exists a need for methods, systems, and computer program products for automatically identifying and validating the source of a malware infection of a computer system.

### SUMMARY

The subject matter described herein includes methods, systems, and computer program products for automatically identifying and validating the source of a malware infection of a computer system. According to one method, an indication of detection of malware on a computer system is received. At least one data transfer operation performed by the computer system prior to a time associated with the indication is repeated. Results of the at least one data transfer operation are monitored for identifying a data transfer operation associated with the malware detection. In response to identifying a data transfer operation associated with the malware detection, an action is taken based on the identified data transfer operation.

The subject matter described herein for automatically identifying and validating a source of a malware infection of a computer system may be implemented using a computer program product comprising computer executable instructions embodied in a computer readable medium. Exemplary computer readable media suitable for implementing the subject matter described herein include chip memory devices, disk memory devices, programmable logic devices, application specific integrated circuits, and downloadable electrical signals. In addition, a computer program product that implements the subject matter described herein may be implemented on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a block diagram of a system for automatically identifying and validating a source of a malware infection of a computer system according to an embodiment of the subject matter described herein;

FIG. 2 is a flow chart illustrating an exemplary process for automatically identifying and validating a source of a malware infection of a computer system according to an embodiment of the subject matter described herein;

FIGS. 3A and 3B are a flow chart illustrating in detail, an exemplary process for automatically identifying and validating a source of a malware infection according to an embodiment of the subject matter described herein; and

FIG. 4 is a block diagram illustrating an alternate system for identifying and validating a source of a malware infection of a computer system according to an embodiment of the subject matter described herein.

### DETAILED DESCRIPTION OF THE INVENTION

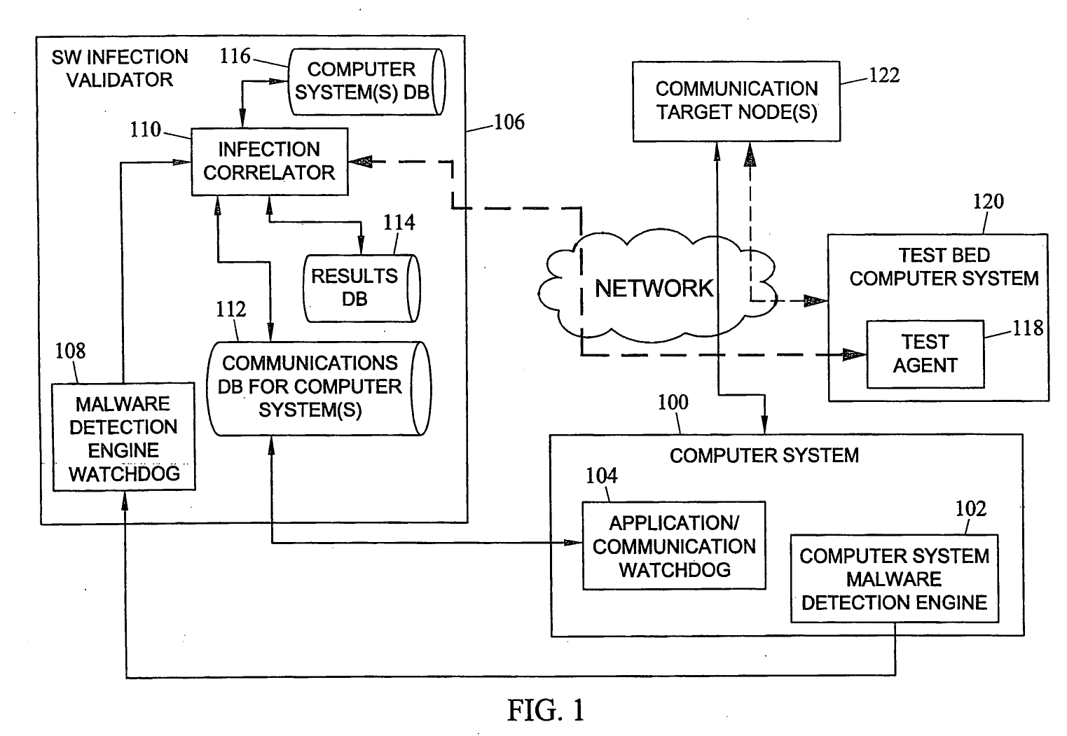

The subject matter described herein includes methods, systems, and computer program products for identifying and validating a source of a malware infection. FIG. 1 is a block diagram illustrating an exemplary system for identifying and validating a source of a malware infection according to an embodiment of the subject matter described herein. Referring to FIG. 1, a computer system 100 may include a computer system malware detection engine 102 and an application/communication watchdog 104. Computer system 100 may be any suitable device with a processing system and memory for storing programs. Examples of computer system 100 include personal computers, personal digital assistants, mobile phones, digital cameras, network infrastructure equipment, home entertainment equipment, or any other device capable of storing and processing information. Computer system malware detection engine 102 may be any suitable program that can identify the presence of malware. For example, malware detection engine 102 may be an antivirus program or a spyware identification and removal program. Examples of programs suitable for use as malware detection engine 102 include Norton Antivirus™ available from Symantec Corporation, SpywareBot available from Spywarebot.com, Inc., and Stinger available from McAfee Corporation. Application/communication watchdog 104 may be any suitable program that logs communication information regarding entities with which computer system 100 communicates. Examples of programs suitable for use as application/communication watchdog 104 include web page loggers that log URLs visited by a web browser, HTTP or FTP loggers that log files transmitted to and from computer system 100 via HTTP or FTP, and any communications logger that is integrated within a communications application. In one implementation, application/communication watchdog 104 may be a component of computer system 100. In an alternate implementation, as will be described in more detail below, application/communication watchdog 104 may be centralized to monitor communications of multiple computer systems.

In the example illustrated in FIG. 1, a software infection validator 106 receives notification of detection of malware on computer system 100, identifies potential malware sources through an analysis of communications records of computer system 100, and creates one or more test cases for identifying and validating a source of a malware infection. Software infection validator 106 may be a stand-alone computer system for identifying and validating malware sources. In an alternate implementation, software infection validator 106 may be a virtual machine that executes on computer system 100. In the illustrated example, software infection validator 106 includes a malware detection engine watchdog 108, an infection correlator 110, a communications database 112, a results database 114, and a computer systems database 116. Malware detection engine watchdog 108 listens for indications of malware from computer system malware detection engines, such as computer system malware detection engine 102. Malware detection engine watchdog 108 may be a server that listens on a port used by malware detection engines to send notifications of detection of malware.

When malware detection engine 102 detects the presence of malware on computer system 100, it may indicate the presence of the malware by sending an alert to malware detection engine watchdog 108. The alert may be sent via any suitable means, such as FTP, HTTP, email, SMS, SNMP, or Syslog forwarding mechanisms. In response to receiving the alert, malware detection engine watchdog 108 may collect information about the malware detection, such as the time of detection, the name of the malware, the infected file name and directory where the malware was detected, and any additional information that malware detection engine 102 may provide. Malware detection engine watchdog 108 may also collect information about computer system 100. Exemplary information that may be collected may include host name, MAC address, IP address, or other information used for identifying computer system 100. Additional information that may be collected about computer system 100 may include processor type, operating system, and installed applications. The information collected regarding computer system 100 may be stored in computer systems database 116. The information collected regarding computer system 100 may include information that uniquely identifies the specific computer system.

Once malware detection engine watchdog 108 receives notification of malware detection, malware detection engine watchdog 108 may inform infection correlator 110. Infection correlator 110 may obtain communications history information from computer system 100 that is stored in database 112 and generate one or more test cases for identifying and validating the source of a malware infection. The test cases may be executed by a test agent 118, which in the illustrated example, resides on a test bed computer system 120. The test cases may include having test agent 118 repeat communications made by computer system 100 with target nodes 122 and record the results. The results may be communicated to infection correlator 110 and stored in results database 114. Once infection correlator 110 validates the source of an infection, correlator 110 may perform an action related to the identified source. Exemplary actions include notifying the user of computer system 100 of the source of the infection, notifying other computer systems of the source of the infection, and configuring a firewall for blocking communications from the source.

In one implementation, infection correlator 110 creates a test record and retrieves a history of data transfer operations associated with computer system 100. The test record may link together data regarding the malware, computer system 100, date and time of the infection, actions and communications executed on computer system 100, and an identifier for computer system 100. Data transfer operations that may be analyzed include website requests, DNS requests, FTP requests, HTTP requests, or any other suitable communication between one or more nodes on a network. Infection correlator 110 may obtain the data transfer information for each computer system 100 being monitored from communications database 112. The information retrieved from database 112 may include target node identification information, (IP address, host name, URL, etc.) date and time of communication session, the user logged into computer system 100 and associated privileges, and the application associated with the data transfer operation.

Correlator 110 may use a configurable time interval for collecting the data transfer operations to be repeated. The time interval may be a predetermined time period before and including the time of detection of the infection. For example, if the infection is detected a given day, the time interval may include one day prior to the time of detection of the infection. Other examples of time intervals may include minutes, days, or weeks preceding the time of detection of the infection.

If the test cases executed by test agent 118 are not successful in validating the source of the malware, the time interval may be varied in order to increase the likelihood of successful validation. In one example, a user may download and store and executable file on computer system 100 on a given day. The executable file itself does not infect computer system 100 until it is executed. If the user waits a week before executing the executable, infection will not occur or be detected until one week after the executable file was downloaded. If the user has not contacted the source of the executable within the week prior to execution, an initial detection interval of one day prior to detection of the infection will not result in successful validation of the source. Accordingly, it may be desirable to increase the time interval to one week prior to the time of detection of the infection, which, in this example, would result in successful validation.

Infection correlator 110 may also use known details about the malware infection to construct a query for creating a subset of data transfer operations that will most likely lead to validation of the source of the malware infection. For example, if the information known about a piece of malware indicates that it is most likely spread by email, infection correlator 110 may structure data transfer operations to be email operations, rather than using other modes of communication.

As described above, application/communication watchdog 104 may store information regarding communications made by computer system 100. In one implementation, application/communication watchdog 104 may forward records about data transfer operations to communications database 112 on a predetermined schedule or in response to requests from software infection validator 106. In order to increase efficiency, limits may be set for the collection of data transfer operations. Exemplary limits that may be set may be based on an IP address range for target nodes, protocol type, time/date, maximum file size for log retention, date since last infection indication, etc. One example of a limitation may be to filter data transfer operations that the network or security administrators do not consider dangerous. For example, DNS, NTP, or DHCP may be excluded from consideration. Another limitation that may be implemented is that trusted devices on a network may be excluded from data collection. Such trusted devices may be identified by any suitable means, such as IP addresses or domain names. Infection correlator 110 may identify the trusted devices and exclude data transfer operations with the trusted devices from the test cases.

In order to obtain a sufficient level of detail for data transfer operations to be used in test cases, one or more of the following tools may be used: a packet sniffing program, network infrastructure logs (i.e., routing tables, switch logs, gateway logs, such as firewall logs), application logs (i.e., browser history), a keystroke logger, an operating system log of computer system 100, or other sources. If application/communication watchdog 104 does not have a specific capability to obtain the necessary data transfer information, it may act as a data broker and forward the details to infection correlator 110.

In addition to having information regarding target nodes 122, a test record may be populated with data about computer system 100, such as operating system, patch level, installed applications, hardware specifications, and any other pertinent configuration data. Infection correlator 110 may receive this information about computer system 110 from computer system database 116. Computer system database 116 may be populated from inventory tracking software, manual data entry software, or through scanning for services and programs.

After obtaining the data transfer information and information about computer system 100, infection correlator 110 may construct the test cases. The test cases may be designed to repeat or reenact the actions taken by computer system 100 around the time of the infection. Test cases can be executed manually or in an automated manner.

In one implementation, the test cases may be set of scripted actions that reproduce the data transfer operations of computer system 100 in the time period prior to the indication of malware. For example, one test case script may be to open a web browser and load a specific URL to retrieve a website and download a file.

The test case scripts can be created manually using scripting tools or may be automatically created. One software tool that may be used to automate the generation of test scripts is replay software designed to reproduce exact actions of a user. An example of this type of software is web replay, available at http://www.codeproject.com/tools/Web_Replay.asp. This software can be utilized by application/communication watchdog 104 to record all of the end user's actions. The software can also be used by test script creators.

Once test cases have been generated for the test record, test bed computing system 120 may be activated. Test bed computing system 120 may be a computing system that is built to mirror the state of computer system 100 that was infected and that started the validation process.

Test bed computing system 120 may be a dedicated computing system or a virtualized computing system. For example, test bed computing system 120 may be a stand-alone hardware platform for identifying and validating malware sources. In a virtualized implementation, test bed computing system 120 may be a virtual machine that executes on computing system 100. Test bed computing system 120 may be tailored to match the state of infected computer system 100 by referencing an inventory management system or may be built from an automated deployment service, which holds configuration data that can be used to create an exact copy of infected computer system 100.

Once test bed computing system 120 has been configured, test agent 118 may be installed. Test agent 118 may execute test scripts to mimic the end users actions. Test agent 118 may be installed in advanced as part of the automated deployment service or set test virtual computing system.

In the example illustrated in FIG. 1, test agent 118 resides on a test bed computing system 120. In an alternate implementation, test agent 118 may be a component of infected computer system 100 or of software infection validator 106.

Each time a test case is executed, test agent 118 may run the malware detection tool that originally gave the indication of malware for computer system 100. If a matching malware indication is give after a particular test case script is executed, test agent 118 may forward the results to infection correlator 110. Infection correlator 110 may store the results in results database 114. Infection correlator 110 may continuously monitor the test case execution by receiving updates from test agent 118 and store the results in results database 114. The monitoring may cease when a test case produces the same malware infection indication that the original alert contained. Infection correlator 110 may make an entry in the test record that links the specific test case script to the indication of malware.

Infection correlator 110 may match the data from the original malware indication and the test case results to produce a finding that identifies how the infection occurs. The reported finding may include information pertinent to the cause of the infection, such as the application used, date and time, user account, website URL, script executed, file downloaded and executed, etc. This information may be used to take any of the above-described actions once the source of the infection has been validated.

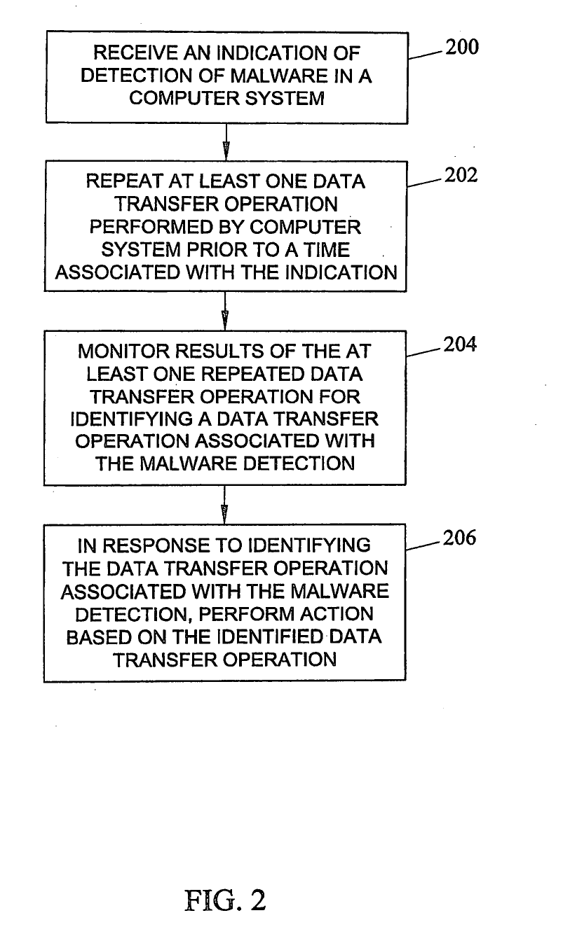

FIG. 2 is a flow chart of an exemplary process for identifying and validating a source of a malware infection of a computer system according to an embodiment of the subject matter described herein. Referring to FIG. 2, in block 200, an indication of detection of malware on a computer system is received. In block 202, one or more data transfer operations performed by the computer system prior to a time associated with the indication are repeated. In block 204, results of the at least one repeated data transfer operation are monitored for identifying a data transfer operation associated with the malware detection.

In response to identifying the data transfer operation associated with the malware detection, an action is performed (block 206). As stated above, the action may be any suitable action, such as blocking the source, notifying the user of the malware source, or notifying other users of the malware source.

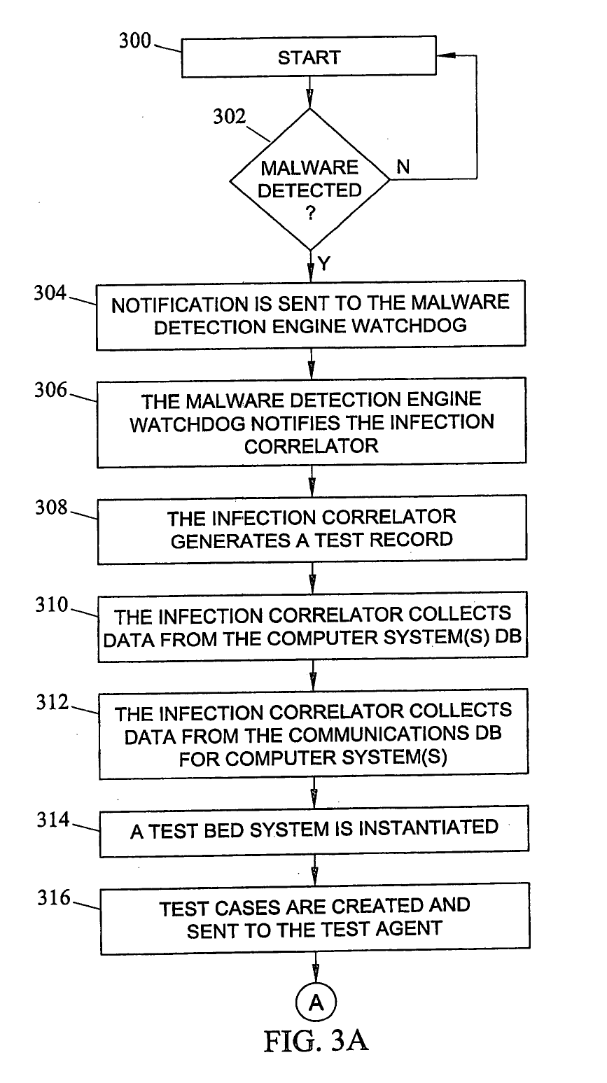

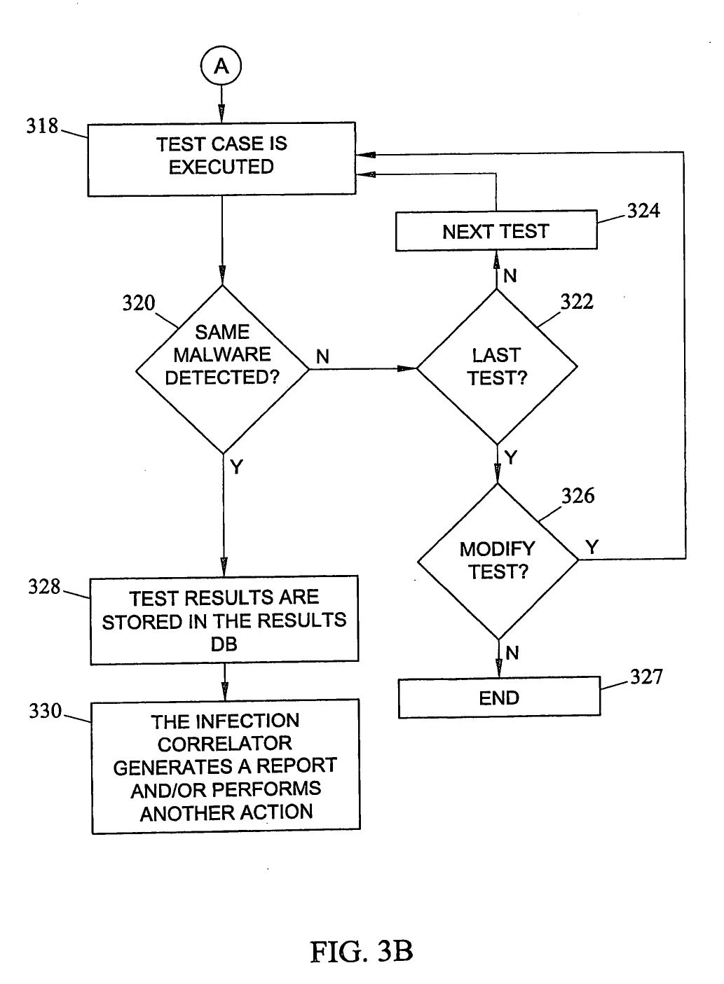

FIGS. 3A and 3B are a flow chart illustrating in detail an exemplary process for automatically identifying and validating a source of a malware infection of a computer system according to an embodiment of the subject matter described herein. Referring to FIG. 3A, in block 300, the process starts. In block 302, it is determined whether malware is detected. If malware is detected, control proceeds to block 304 where notification is sent to malware detection engine watchdog 108.

In block 306, malware detection engine watchdog 108 notifies infection correlator 110. In block 308, infection correlator 110 generates a test record. In block 310, infection correlator 110 collects data from computer systems database 116. In block 312, infection correlator 110 collects data from communications database 112 for computer system 100.

In block 314, a test bed system is instantiated. In block 316, test cases are created and sent to test agent 118. The test cases may be created by infection correlator 110.

Referring to FIG. 3B, in block 318, the test case is executed. In block 320, it is determined whether the same malware identified by the alert is detected. If the same malware is not detected, control proceeds to block 322 where it is determined whether the current test is the last test. If the current test is not the last test, control proceeds to block 324 where the next test is selected. Control then returns to block 318 where the test is executed. In block 322, if the current test is the last test, control proceeds to block 326 where it is determined whether the user desires to modify the test or whether infection correlator 110 is configured to automatically modify the test. Modifying the test may include increasing the time interval for detecting the malware source. If it is not desirable to modify the test, the process may end. If it is desirable to modify the test, control may proceed to block 318 where the modified tests are executed.

Returning to block 320, if the same malware is detected, control proceeds to block 328 where the test results are stored in results database 114. Control then proceeds to block 330 where infection correlator 110 generates a report and/or performs another action based on the results.

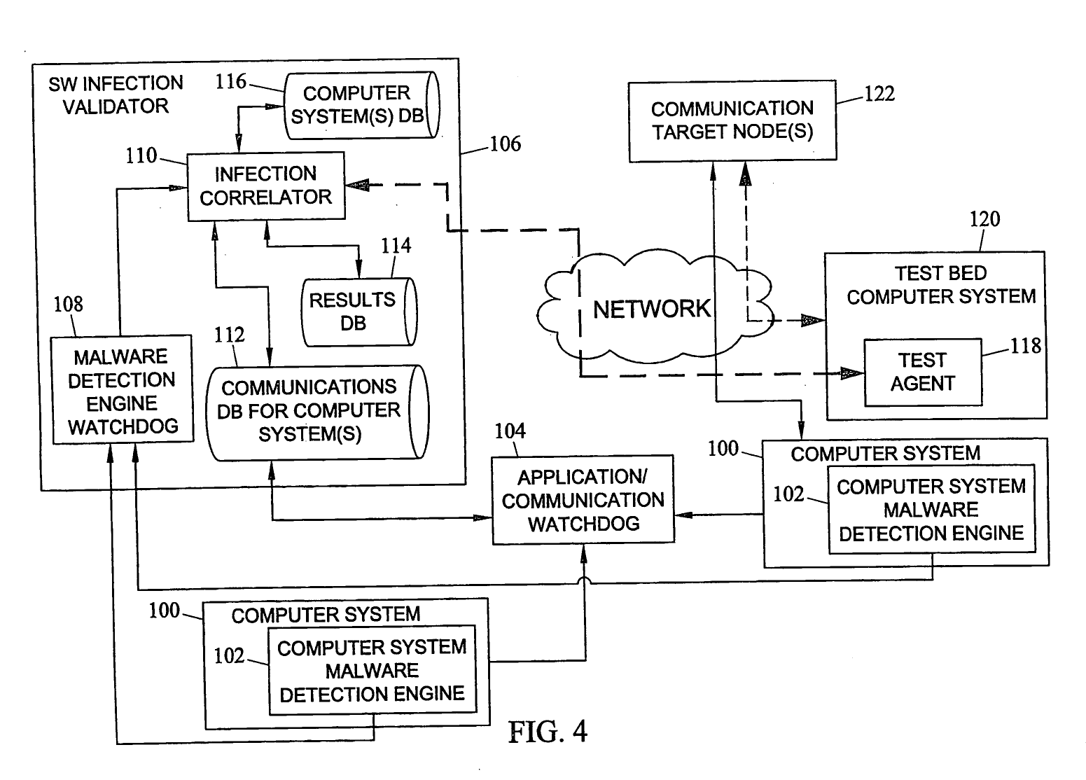

In the example illustrated in FIG. 1, application/communication watchdog 104 that creates communications log is resident on computer system 100. In an alternate implementation, the functionality of application/communication watchdog 104 may be centralized. FIG. 4 is a block diagram illustrating an exemplary system for identifying and validating the source of a malware infection of a computer system where application/communication watchdog 104 is centralized. In FIG. 4, application/communication watchdog 104 may create communications logs for communications made to and from a plurality of computer systems 100. Other than the centralized logging, the functionality of the system illustrated in FIG. 4 is the same as that illustrated in FIG. 1.

According to one aspect, the subject matter described herein may include a system for identifying and validating a source of a malware infection of a computer system. The system may include means for receiving an indication of detection of malware on a computer system. For example, malware detection engine watchdog 108 may receive an indication that malware has been detected on a computer system 100.

The system may further include means for repeating at least one data transfer operation performed by the computer system prior to a time associated with the indication. For example, infection correlator 110 may generate one ore more test cases to be executed by test agent 118. The test cases may replicate data transfer actions of computer system 100 prior to malware detection.

The system may further include means for monitoring results of at least one repeated data transfer operation for identifying a data transfer operation associated with the malware detection. For example, infection correlator 110 may monitor the results of test being executed by test agent 118 to identify a data transfer operation that results in the same malware identified in the indication.

The system may further include means for, in response to identifying the data transfer operation associated with the malware detection, performing an action based on the identified data transfer operation. For example, infection correlator 110 may inform the user of computer system 100 of the source of the malware, inform other computer systems of the source of the malware, and/or configure a firewall to block the source of the malware.

It will be understood that various details of the invention may be changed without departing from the scope of the invention. Furthermore, the foregoing description is for the purpose of illustration only, and not for the purpose of limitation.

What is claimed is:

1. A method for automatically identifying and validating a source of a malware infection of a computer system, the method comprising:
receiving an indication of detection of malware in a computer system;
repeating at least one data transfer operation performed by the computer system prior to a time associated with the indication;
monitoring results of the at least one repeated data transfer operation for identifying a data transfer operation associated with the malware detection; and
in response to identifying a data transfer operation associated with the malware detection, performing an action based on the identified data transfer operation.

2. The method of claim 1 wherein the malware comprises unauthorized software present in the computer system.

3. The method of claim 2 wherein the unauthorized software comprises one of a virus, spyware, and a worm.

4. The method of claim 1 wherein repeating at least one data transfer operation comprises:
obtaining communication history of the computer system for a configurable time interval;
identifying, from the obtained communication history, potential sources of the malware; and
initiating data transfer operations with the potential sources of the malware.

5. The method of claim 4 comprising, in response to failing to identify the data transfer operation associated with the malware detection, altering the time interval, obtaining communication history of the computer system for the altered time interval, identifying, from the communication history for the altered time interval, additional potential sources of the malware, and repeating data transfer operations performed by the computer system with the additional potential sources.

6. The method of claim 4 wherein obtaining the communication history includes obtaining the communication history from at least one of a web browser on the computer system, an application on the computer system separate from a web browser, and a gateway for connecting the computer system to at least one additional computer system.

7. The method of claim 1 wherein repeating at least one data transfer operation includes repeating the at least one data transfer operation using the computer system.

8. The method of claim 1 wherein repeating at least one data transfer operation includes repeating the at least one data transfer operation using a test bed computer system that is separate from the computer system.

9. The method of claim 1 wherein repeating at least one data transfer operation includes identifying a type of data transfer operation associated with the malware infection and repeating data transfer operations of the identified type.

10. The method of claim 1 wherein repeating at least one data transfer operation includes excluding from the repeating, data transfer operations from trusted sources.

11. The method of claim 1 wherein performing an action includes indicating a source of the malware to a user.

12. The method of claim 1 wherein performing an action includes configuring a firewall for blocking a source of the malware.

13. The method of claim 1 wherein performing an action includes communicating a source of the malware to at least one additional computer system.

14. A system for automatically identifying and validating a source of a malware infection of a computer system, the system comprising:
a malware detection engine watchdog for receiving an indication of detection of malware in a computer system;
a test agent for repeating at least one data transfer operation performed by the computer system prior to a time associated with the indication; and
an infection correlator for monitoring results of the at least one data transfer operation for identifying a data transfer operation associated with the malware detection, and, in response to identifying a data transfer operation associated with the malware detection, for performing an action based on the identified data transfer operation associated with the malware detection.

15. The system of claim 14 wherein the malware comprises unauthorized software present on the computer system.

16. The system of claim 15 wherein the malware comprises one of a virus, spyware, and a worm.

17. The system of claim 14 wherein the infection correlator is adapted to obtain a communication history of the computer system for a configurable time interval, to identify, from the obtained communication history, potential sources of the malware, and to create a test case for instructing the test agent to initiate data transfer operations with the potential sources of the malware.

18. The system of claim 17 wherein, in response to failure to identify the data transfer operation associated with the malware detection, the infection correlator is adapted to alter the time interval, to obtain a communication history of the computer system for the altered time interval, to identify, from the communication history for the altered time interval, additional potential sources of the malware, and to repeat data transfer operations performed by the computer system with the additional potential sources.

19. The system of claim 17 wherein the infection correlator is adapted to obtain the communication history from at least one of a communication history log associated with a web browser on the computer system, a log maintained by a communications application other than a web browser and present on the computer system, and a log maintained by a gateway for connecting the computer system to at least one additional computer system.

20. The system of claim 17 wherein the infection correlator is adapted to identify a type of communications associated with the malware infection and to structure the test case to initiate communications of the identified type.

21. The system of claim 17 wherein the infection correlator is adapted to exclude from the test case, data transfer operations with trusted sources.

22. The system of claim 14 wherein the agent is located on the computer system on which the malware was detected.

23. The system of claim 14 comprising a test bed computer system separate from the computer system on which the malware is detected, wherein the agent is located on the test bed computer system.

24. The system of claim 14 wherein the action includes indicating a source of the malware to a user.

25. The system of claim 14 wherein the action includes configuring a firewall for blocking a source of the malware.

26. The system of claim 14 wherein the action includes communicating a source of the malware to at least one additional computer system.

27. A system for automatically identifying and validating a source of a malware infection of a computer system, the system comprising:
means for receiving an indication of detection of malware in a computer system;
means for repeating at least one data transfer operation performed by the computer system prior to a time associated with the indication;
means for monitoring results of the at least one repeated data transfer operation for identifying a data transfer operation associated with the malware detection; and
means for, in response to identifying a data transfer operation associated with the malware detection, performing an action based on the identified data transfer operation.

28. A computer program product comprising computer executable instructions embodied in a computer readable medium for performing steps comprising:
receiving an indication of detection of malware in a computer system;
repeating at least one data transfer operation performed by the computer system prior to a time associated with the indication;
monitoring results of the at least one repeated data transfer operation for identifying a data transfer operation associated with the malware detection; and
in response to identifying a data transfer operation associated with the malware detection, performing an action based on the identified data transfer operation.
